(19) United States
(12) Patent Application Publication
(10) Pub. No.: US 2008/0198073 A1
(43) Pub. Date: Aug. 21, 2008

(54) Method for adjusting a PCB antenna and a structure thereof

(75) Inventor: Ming-Hao Yeh, Zhubei City (TW)

Correspondence Address: REED SMITH LLP, 3110 FAIRVIEW PARK DRIVE, SUITE 1400, FALLS CHURCH, VA, 22042, US

(73) Assignee: MediaTek Inc.

(21) Appl. No.: 11/707,148

(22) Filed: Feb. 16, 2007

(51) Int. Cl. H01Q 1/00

(52) U.S. Cl. 343/700 MS

(57) ABSTRACT

A PCB antenna, comprising: a substrate; a radiator, patterned on the substrate, having a branch point; a ground on the substrate; a short path, patterned on the substrate, having two ends where one end is connected to the ground and the other end is connected to the branch point of the radiator; and at least one passive element coupled between the radiator and the short path, is disclosed. The resonant frequency and/or the input impedance of the PCB antenna can be adjusted according to a distance between the passive element and the branch point of the radiator.

### FIELD OF INVENTION

The invention is related to a printed circuit board (PCB) antenna used in various applications, such as telecommunication systems, and more particularly related to a method for adjusting a resonant frequency and an input impedance of the antenna and a structure thereof.

### BACKGROUND OF THE INVENTION

PCB antennas are sensitive to surroundings including PCB material, layout, nearby components, metal materials, housings and so on. For example, two PCB antennas with the same size patterned on different PCBs may demonstrate different performances. Even two identical antennas may have two distinct resonant frequency values and input impedance values when used in different products. If the resonant frequency shifts out of band, the input impedance increases/decreases beyond tolerance or other performances beyond tolerance, the designer will encounter a big problem in designing and verifying procedures of the antenna.

Generally, a larger-sized PCB antenna may have a wider band in comparison with a small-sized PCB antenna. Therefore, if there is enough space for a larger-sized PCB antenna, a larger-sized PCB antenna is preferred to overcome the shift of frequency and the input impedance increase/decrease. Nevertheless, a larger-sized PCB antenna is obviously unsuitable to be implanted in portable electronic communication devices, because such applications are getting much smaller. The condition becomes worse when the portable electronic communication devices require multiple antennas for multiple applications, e.g. cellular, GPS, Bluetooth and so on.

When a PCB antenna designed for a specific product is tested and found that its resonant frequency is out of band, input impedance is beyond tolerance or other performances are beyond tolerance, the layout of the PCB antenna will be redesigned to form a modified PCB antenna accordingly. The design and test procedures will be continuously performed until the modified PCB antenna passes the verification test. Besides, if the housing or the PCB material of the product is changed by manufacturers due to some reasons, it usually needs a PCB antenna of new version to fit the change of the surroundings, which is time consuming and cost effective.

For a designer, adding a matching circuit to a feed pin of the PCB antenna without adjusting the layout of the PCB antenna is another practicable manner. However, there are only several specific matching circuits available in the markets and the properties of matching circuits are different based on different suppliers, such that the performances of the PCB antennas having different matching circuits are discrete. That is, the PCB antenna resonates at M frequency when a M matching circuit is added to the PCB antenna, and the PCB antenna resonates at N frequency when a N matching circuit is added to the PCB antenna. And the designer cannot make the PCB antenna operate at an arbitrarily frequency between M and N because a suitable matching circuit is unavailable.

Thus, there is a need for a method for adjusts the resonant frequency, the input impedance and other performances of a PCB antenna effectively and economically, and a structure thereof.

### SUMMARY OF THE INVENTION

In the present invention, a PCB antenna, comprising: a substrate; a radiator, patterned on the substrate, having a branch point; a ground on the substrate; a short path, patterned on the substrate, having two ends where one end is connected to the ground and the other end is connected to the branch point of the radiator; and at least one passive element coupled between the radiator and the short path, is disclosed. The resonant frequency and/or the input impedance of the PCB antenna can be adjusted according to a distance between the passive element and the branch point of the radiator.

### BRIEF DESCRIPTION OF THE DRAWINGS

FIG. 1A shows a perspective view of a PCB antenna;

FIG. 1B shows a top view of the PCB antenna illustrated in FIG. 1A;

FIG. 1C shows a curve of the return loss measurement of the PCB antenna illustrated in FIG. 1A;

FIG. 1D shows a Smith Chart of the impedance of the PCB antenna illustrated in FIG. 1A;

FIG. 2A shows a top view of a PCB antenna;

FIG. 2B shows a curve of the return loss measurement of the PCB antenna illustrated in FIG. 2A,

FIG. 2C shows a Smith Chart of the impedance of the PCB antenna illustrated in FIG. 2A,

FIG. 3A shows a bottom view of a PCB antenna,

FIG. 3B shows a curve of the return loss measurement of the PCB antenna illustrated in FIG. 3A,

FIG. 3C shows a Smith Chart of the impedance of the PCB antenna illustrated in FIG. 3A,

FIG. 4A shows a top view of a PCB antenna,

FIG. 4B shows a curve of the return loss measurement of the PCB antenna illustrated in FIG. 4A,

FIG. 4C shows a Smith Chart of the impedance of the PCB antenna illustrated in FIG. 4A,

FIG. 5A shows a bottom view of a PCB antenna,

FIG. 5B shows a curve of the return loss measurement of the PCB antenna illustrated in FIG. 5A,

FIG. 5C shows a Smith Chart of the impedance of the PCB antenna illustrated in FIG. 5A,

FIG. 6A shows a curve of the return loss measurement of a PCB antenna illustrated in FIG. 4A,

FIG. 6B shows a Smith Chart of the impedance of the PCB antenna illustrated in FIG.4A,

FIG. 7A shows a curve of the return loss measurement of a PCB antenna illustrated in FIG. 5A,

FIG. 7B shows a Smith Chart of the impedance of the PCB antenna illustrated in FIG. 5A,

FIG. 8A shows a top view of a PCB antenna,

FIG. 8B shows a curve of the return loss measurement of the PCB antenna illustrated in FIG. 8A,

FIG. 8C shows a Smith Chart of the impedance of the PCB antenna illustrated in FIG. 8A,

FIG. 9A shows a bottom view of a PCB antenna,

FIG. 9B shows a curve of the return loss measurement of the PCB antenna illustrated in FIG. 9A,

FIG. 9C shows a Smith Chart of the impedance of the PCB antenna illustrated in FIG. 9A,

FIG. 10A shows a curve of the return loss measurement of a PCB antenna illustrated in FIG. 8A,

FIG. 10B shows a Smith Chart of the impedance of the PCB antenna illustrated in FIG. 8A,

FIG. 11A shows a curve of the return loss measurement of a PCB antenna illustrated in FIG. 9A, and

FIG. 11B shows a Smith Chart of the impedance of the PCB antenna illustrated in FIG. 9A.

### DETAILED DESCRIPTION

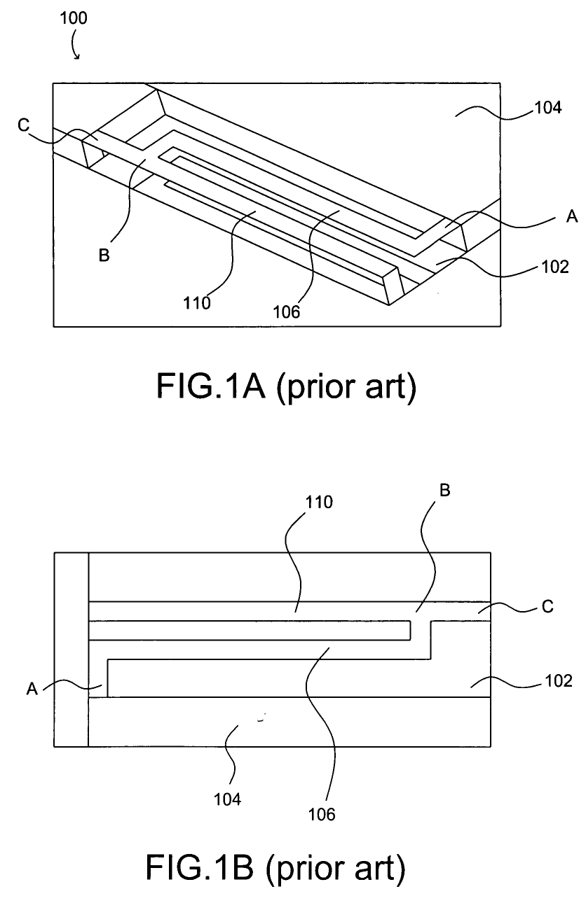

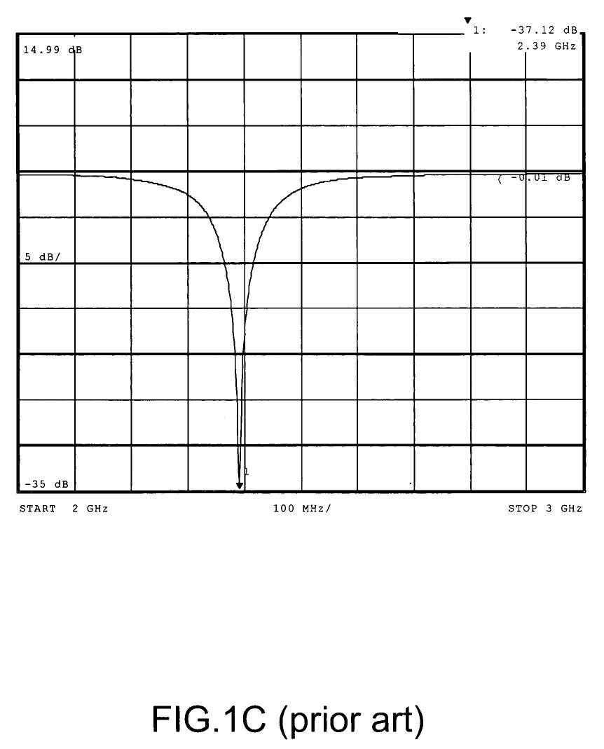

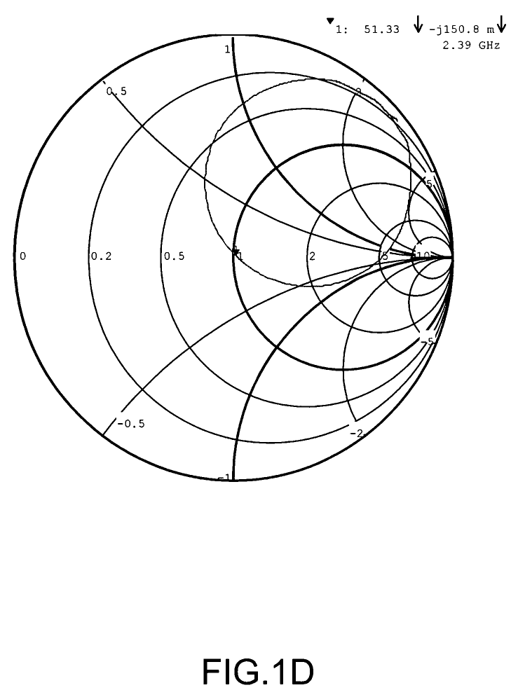

A compact PCB antenna is disclosed. In the following, the present invention can be further understood by referring to the exemplary, but not limiting, descriptions accompanied with the drawings in FIG. 1 to FIG. 11.

Now referring to FIG. 1A, a perspective view of a PCB antenna 100 is shown. The PCB antenna 100 includes a substrate 102, having a top surface and a bottom surface, a radiator 110 patterned on the substrate 102, a ground 104 on the substrate 102, and a shorting path 106 patterned on the substrate 102. Specifically, the substrate 102 is a printed circuit board, such as FR4, FR408, or Rogers 4003 as known to those skilled in the art. One end of the shorting path 106 is connected to the ground 104 at point A and the other end of the shorting path 106 is connected to the radiator 110 at a branch point, namely point B. One end of the radiator 110 has a feed pin, namely point C, and the other end of the radiator 110 further extends to the bottom surface of the substrate 102 through a via hole. In addition, a top view of the PCB antenna 100 is shown in FIG. 1B, and the experimental results of the PCB antenna 100 are shown in FIG. 1C and FIG. 1D. Through FIG. 1B, the top surface of the substrate 102 can be seen. From FIG. 1C, the return loss measurement (S11) shows that the resonant frequency of the PCB antenna 100 is 2.39 GHz. In FIG. 1D, the Smith Chart plots the reflection coefficient in the complex plane, and it shows that the impendence of the PCB antenna 100 is near 50Ω. Notably, the return loss is defined as the absolute value of the reflection coefficient in dB, and the return loss measurement and the reflection coefficient can be measured by a Vector Signal Analyzer or other instruments as known to those in the art.

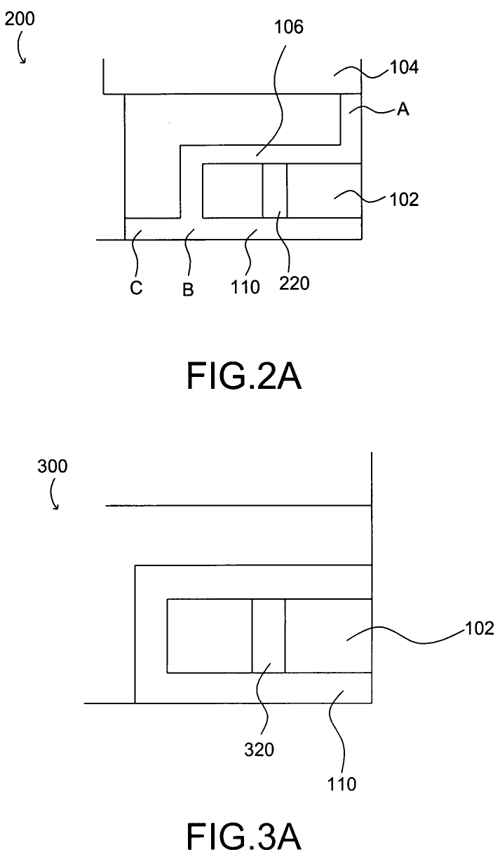

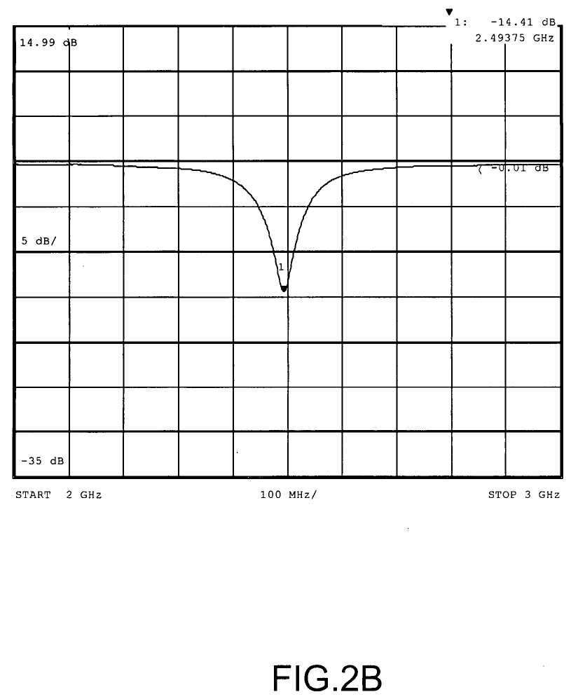

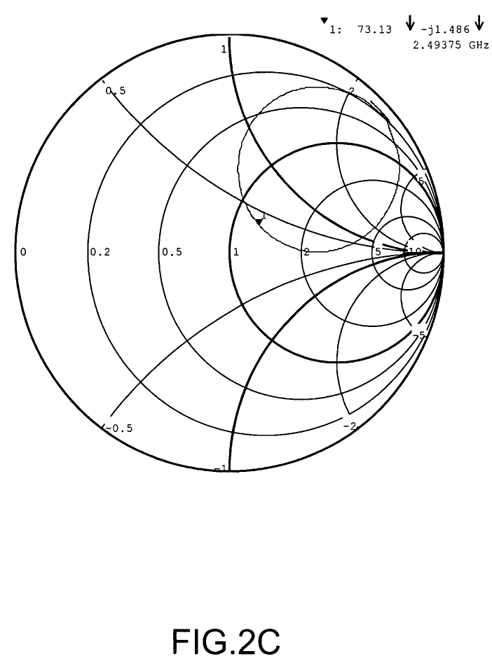

In one embodiment, referring to FIG. 2A, the present invention adds a 0402 resistor 220 on the top surface of the substrate 102 to form a PCB antenna 200, wherein one end of the 0402 resistor 220 is connected to the radiator 110 and the other end is connected to the short path 106. The experimental results of the PCB antenna 200 are shown in FIG. 2B and FIG. 2C. From FIG. 2B, the return loss measurement (S11) shows that the resonant frequency of the PCB antenna 200 is shifted from 2.39 GHz (shown in FIG. 1C) to 2.49 GHz. From FIG. 2C, the Smith Chart shows that the impendence of the PCB antenna 200 is shifted from about 50Ω (shown in FIG. 1D) to a higher value about 70Ω.

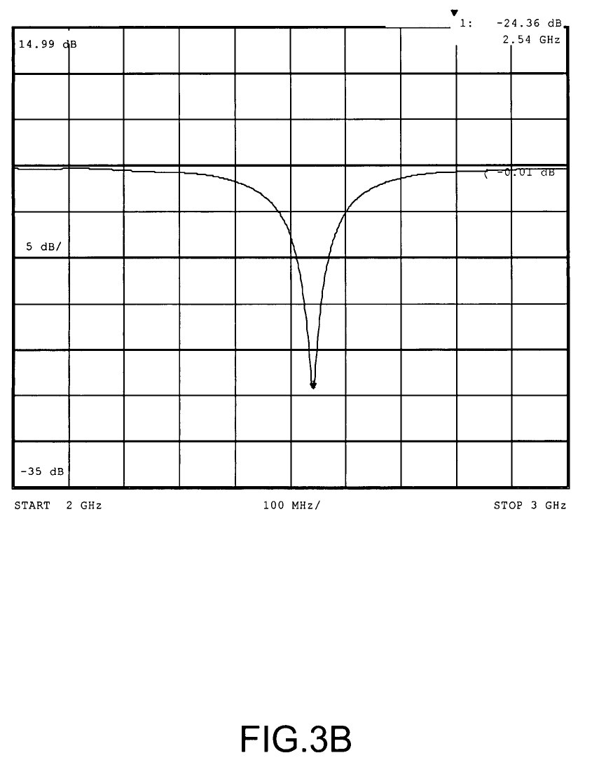

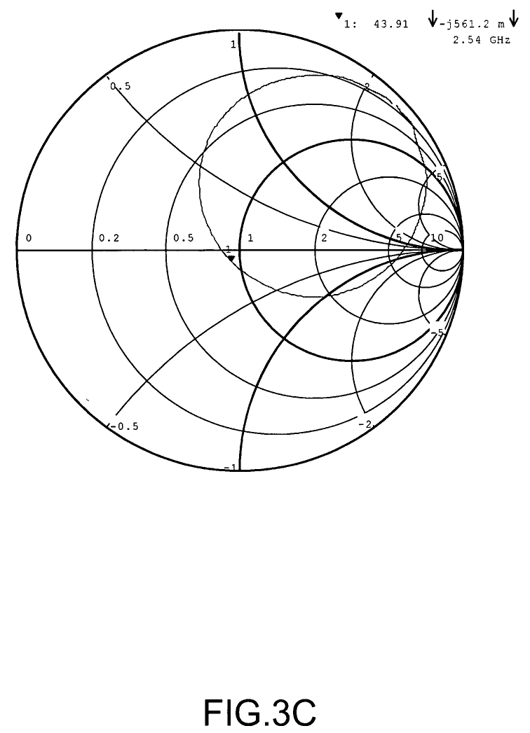

In another embodiment, the present invention adds a 0402 resistor 320 on the bottom surface of the substrate 102 to form a PCB antenna 300, wherein the 0402 resistor 320 bypasses the radiator 110, as shown in FIG. 3A. The experimental results of the PCB antenna 300 are shown in FIG. 3B and FIG. 3C. FIG. 3A is a bottom view of the PCB antenna 300, and the radiator 110 shown in FIG. 3A is extended from the top surface of the substrate 102 through the via hole as described above. That is, FIG. 2A and FIG. 3A are the top view and the bottom view of the PCB antenna shown in FIG. 1A respectively, except the 0402 resistors 220 and 320 are added on different surfaces. From FIG. 3B, the return loss measurement (S11) shows that the resonant frequency of the PCB antenna 300 is shifted from 2.39 GHz (shown in FIG. 1C) to 2.54 GHz. From FIG. 3C, the Smith Chart shows that the impendence of the PCB antenna 300 is shifted from about 50Ω (shown in FIG. 1D) to a lower value about 40Ω.

It should be noted that “the 0402 resistor 320 bypasses the radiator 110” described above means that one end of the 0402 resistor 320 is connected to the radiator 110 at one point and the other end of the 0402 resistor 320 is connected to the radiator 110 at another point. Accordingly, the term “bypass” means joining two points in the radiator 110. Furthermore, not only 0402 resistors can be added in the present invention, another passive element, such as different resistors, such as 0201, 0402, 0603, 0805, 1206, 1210, 2010, 1812, 2512, capacitors or inductors, may also be utilized for different purposes.

It should also be noted that though only one resistor is mounted on the PCB antenna 200 and 300 respectively, the present invention might mount more than one resistor on the top surface or bottom surface of a PCB antenna. Besides/more than one resistor may be mounted both on the top and bottom surface of a PCB antenna. Furthermore, not only resistors can be utilized in present invention, other passive element, such as capacitors, inductors or combination, thereof may also be utilized.

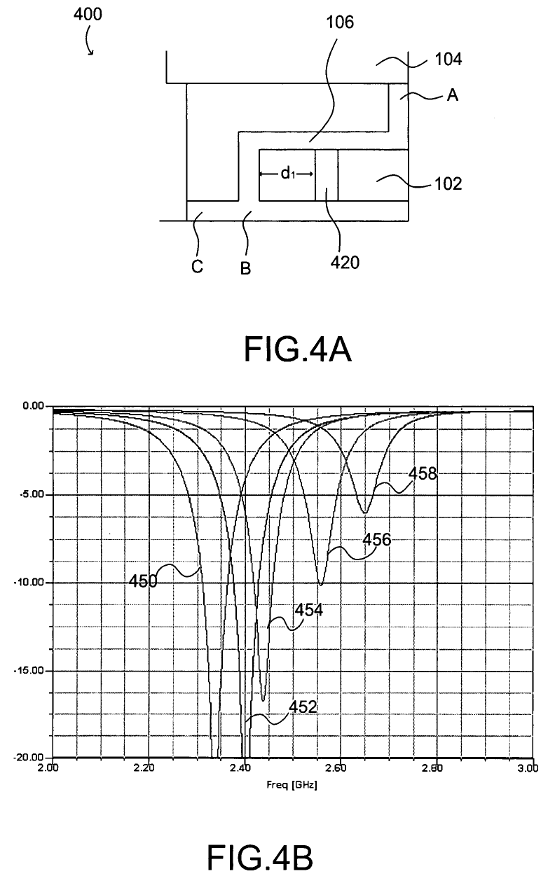

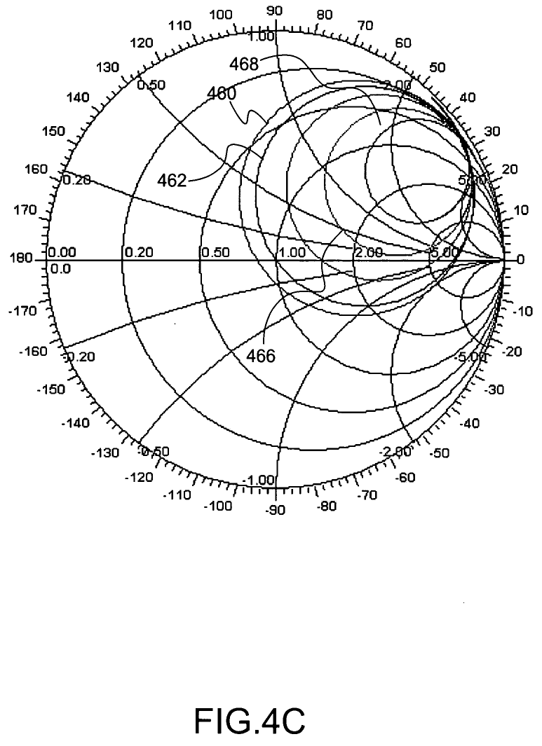

Although a resistor is mounted on the PCB antenna 200 or 300, an inductor may be used in the present invention. Specifically, if the 0402 resistor 220 in FIG. 2A is replaced by a 0402 inductor 420 with inductance of 1.5 nH to form a PCB antenna 400 as shown in FIG. 4A. The experimental results of the PCB antenna 400 are shown in FIG. 4B and FIG. 4C. Five curves 450, 452, 454, 456 and 458 are depicted in FIG. 4B based on increasing/decreasing the distance “d₁” labeled in FIG. 4A. The curve 452 is depicted while d₁=1 mm. The curve 454 is depicted while d₁=3 mm. The curve 456 is depicted while d₁=5 mm. The curve 458 is depicted while d₁=7 mm. The curve 450 is depicted while no element added. Five curves 460, 462, 464, 466 and 468 are also depicted in FIG. 4C corresponding to the curves 450, 452, 454, 456 and 458. As a result, the curves depicted in FIG. 4B show that the longer the d₁ the higher the resonant frequency of the PCB antenna 400, and the curves depicted in FIG. 4C show that the longer the d₁ the higher the impedance of the PCB antenna 400. In other words, the PCB antenna 400 of the present invention can achieve the desired resonant frequency, impedance or other performances by adjusting the distance d₁.

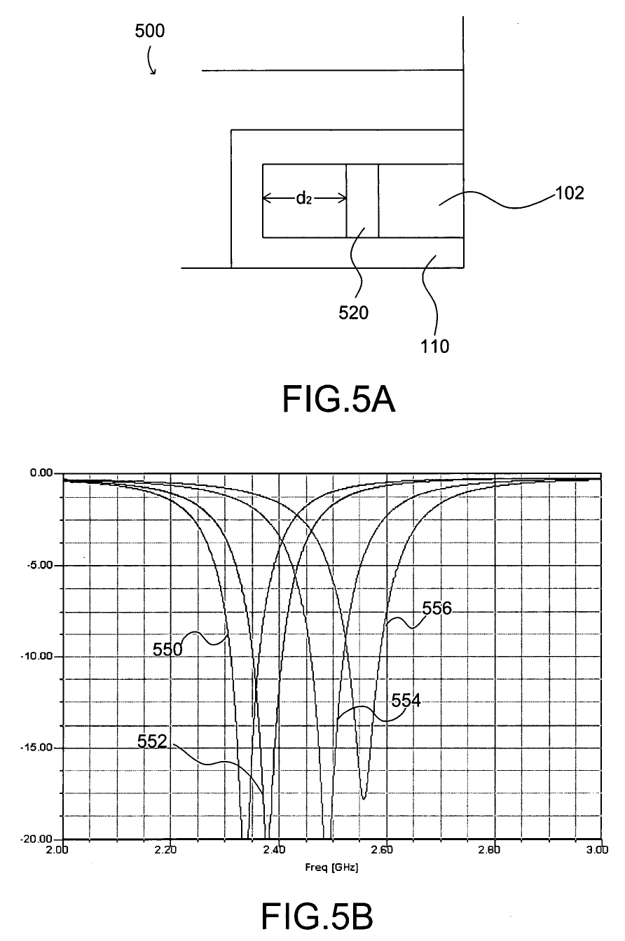

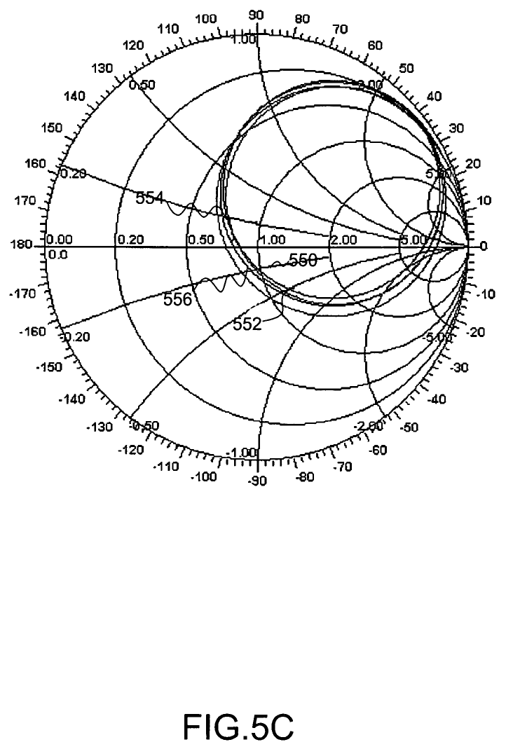

Moreover, if the 0402 resistor 320 in FIG. 3A is replaced by a 0402 inductor 520 with inductance of 1.5 nH to form a PCB antenna 500 as shown in FIG. 5A, the experimental results of the PCB antenna 500 are shown in FIG. 5B and FIG. 5C. There are four curves 550, 552, 554 and 556 depicted in FIG. 5B based on increasing/decreasing the distance “d₂” labeled in FIG. 5A. The curve 552 is depicted while d₂=1 mm. The curve 554 is depicted while d₂=3 mm. The curve 556 is depicted while d₂=5 mm. And, the curve 550 is depicted while no element been mounted. There are also four curves 560, 562, 564 and 566 depicted in FIG. 5C corresponding to the curves 550, 552, 554 and 556. As a result, the curves depicted in FIG. 5B show that the longer the d₂ the higher the resonant frequency of the PCB antenna 500, and the curves depicted in FIG. 5C show that the longer the d₂ the lower the impedance of the PCB antenna 500. In other words, the PCB antenna 500 of the present invention can achieve the desired resonant frequency, impedance or other performances by adjusting the distance d₂. However, the variations in impedance are slight.

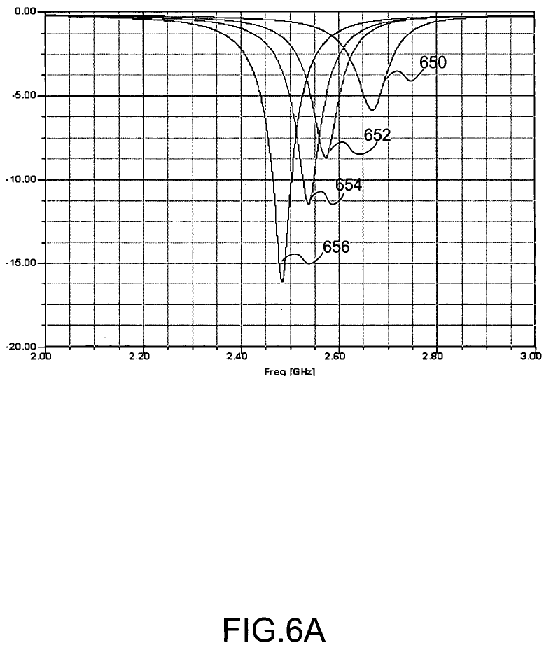

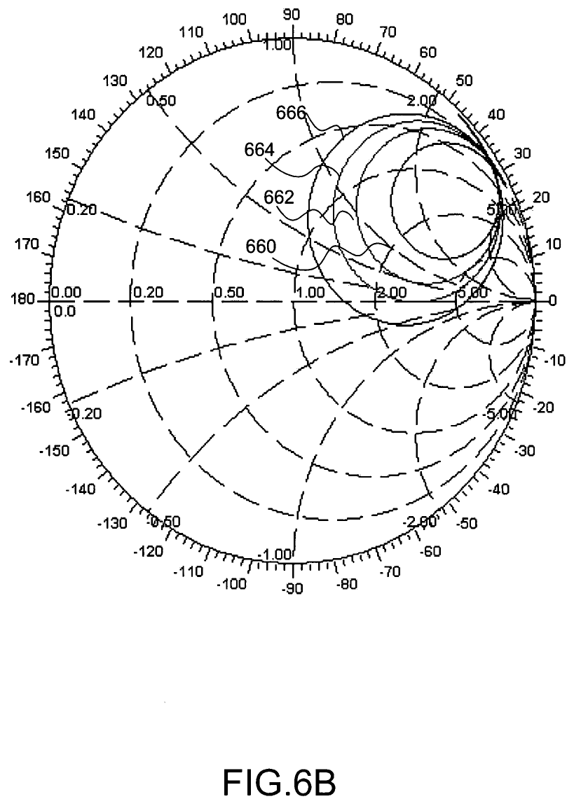

Back to FIG. 4A, if d₁ is fixed at 5mm and the inductance of the 0402 inductor 420 is varied, the experimental results of the PCB antenna 400 are shown in FIG. 6A and FIG. 6B. There are four curves 650, 652, 654 and 656 depicted in FIG. 6A. The curve 652 is depicted when the inductance of the 0402 inductor 420 has a value of 1 nH. The curve 654 is depicted when the inductance of the 0402 inductor 420 has a value of 2 nH. The curve 656 is depicted when the inductance of the 0402 inductor 420 has a value of 4 nH. And, the curve 650 is depicted when a 0 nH element mounted. There are also four curves 660, 662, 664 and 666 depicted in FIG. 6B corresponding to the curves 650, 652, 654 and 656. As a result, the curves depicted in FIG. 6A show that the larger the inductance added, the lower the resonant frequency of the PCB antenna 400, and the curves depicted in FIG. 6B show that the larger the inductance added, the lower the impedance of the PCB antenna 400.

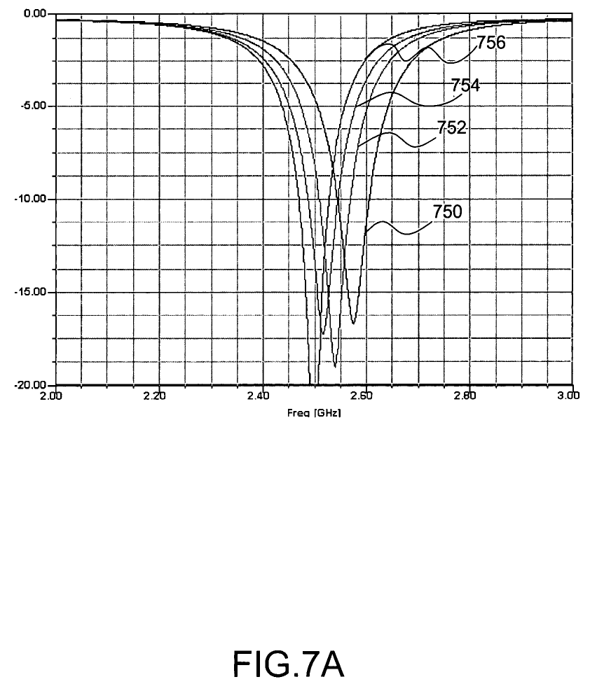

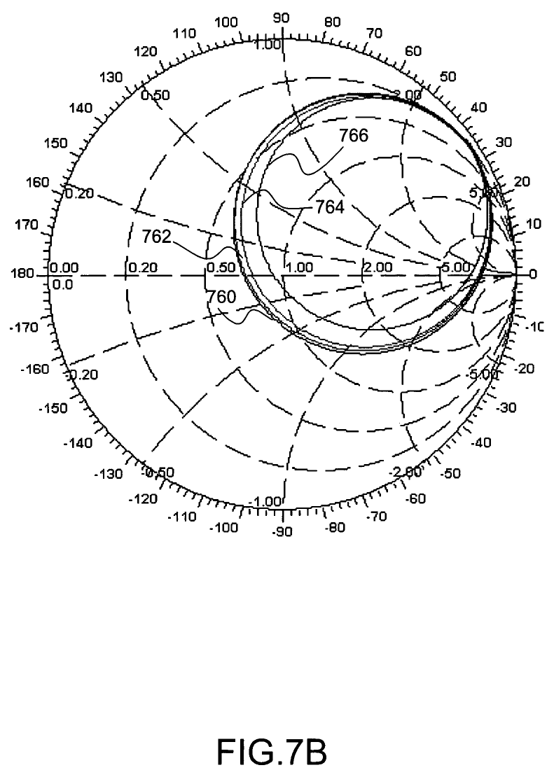

Back to FIG. 5A, if d₂ is fixed at 5 mm and the inductance of the 0402 inductor 520 is varied, the experimental results of the PCB antenna 500 are shown in FIG. 7A and FIG. 7B. There are four curves 750, 752, 754 and 756 depicted in FIG. 7A. The curve 752 is depicted when the inductance of the 0402 inductor 420 has a value of 1 nH. The curve 754 is depicted when the inductance of the 0402 inductor 420 has a value of 2 nH. The curve 756 is depicted when the inductance of the 0402 inductor 420 has a value of 4 nH. The curve 750 is depicted when a 0 nH element added. There are also four curves 760, 762, 764 and 766 depicted in FIG. 7B corresponding to the curves 750, 752, 754 and 756. As a result, the curves depicted in FIG. 7A show that the larger the inductance the lower the resonant frequency of the PCB antenna 500, and the curves depicted in FIG. 7B show that the larger the inductance the higher the impedance of the PCB antenna 500.

It should be noted that, from FIG. 6A, FIG. 6B, FIG. 7A and FIG. 7B, the variations in resonant frequency and impedance are enlarged with the inductance of the 0402 inductor decreasing.

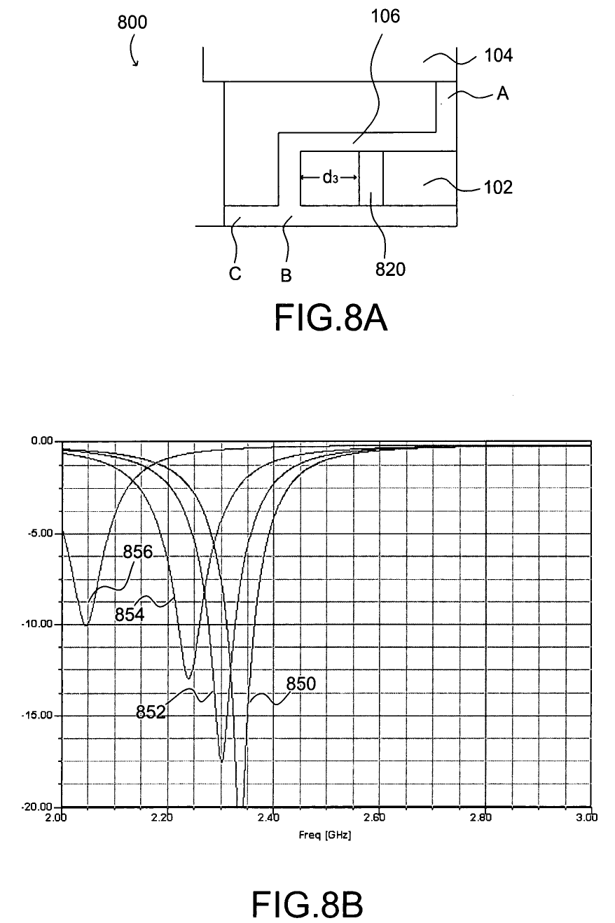

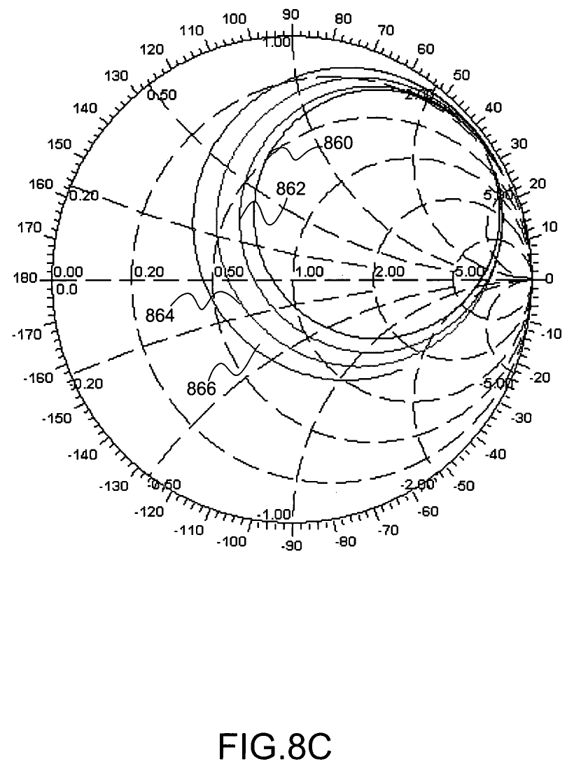

Although a resistor or an inductor is mounted on the PCB antenna 200, 300, 400 or 500, a capacitor may be used in the present invention. Specifically, if the 0402 resistor 220 in FIG. 2A is replaced by a 0402 capacitor 820 with capacitance of 1.5 pF to form a PCB antenna 800 as shown in FIG. 8A. The experimental results of the PCB antenna 800 are shown in FIG. 8B and FIG. 8C. There are four curves 850, 852, 854 and 856 depicted in FIG. 8B based on increasing/decreasing the distance “d₃” labeled in FIG. 8A. The curve 852.is depicted while d₃=1 mm. The curve 854 is depicted while d₃=2 mm. The curve 856 is depicted while d₃=3 mm. And, the curve 850 is depicted while no element been mounted. There are also four curves 860, 862, 864 and 866 depicted in FIG. 8C corresponding to the curves 850, 852, 854 and 856. As a result, the curves depicted in FIG. 8B show that the longer the d₃ the lower the resonant frequency of the PCB antenna 800, and the curves depicted in FIG. 8C show that the longer the d₃ the lower the impedance of the PCB antenna 800.

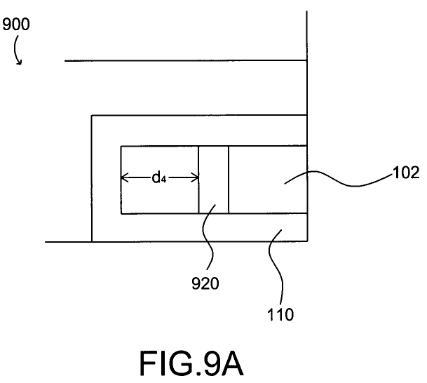

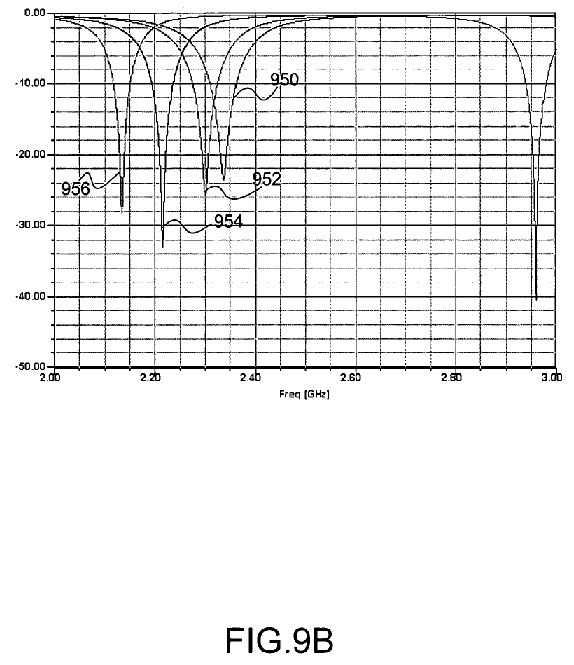

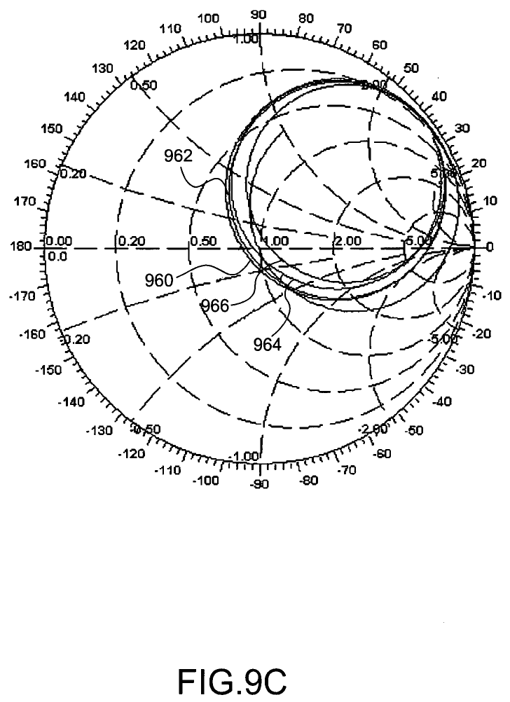

Moreover, if the 0402 resistor 320 in FIG. 3A is replaced by a 0402 capacitor 920 with capacitance of 1.5 pF to form a PCB antenna 900 as shown in FIG. 9A, the experimental results of the PCB antenna 900 are shown in FIG. 9B and FIG. 9C. There are four curves 950, 952, 954 and 956 depicted in FIG. 9B based on increasing/decreasing the distance “d₄” labeled in FIG. 9A. The curve 952 is depicted while d₄=1 mm. The curve 954 is depicted while d₄=1.5 mm. The curve 956 is depicted while d₄=2 mm. And, the curve 950 is depicted while no element been mounted. There are also four curves 960, 962, 964 and 966 depicted in FIG. 9C corresponding to the curves 950, 952, 954 and 956. As a result, the curves depicted in FIG. 9B show that the longer the d₄ the lower the resonant frequency of the PCB antenna 900, and the curves depicted in FIG. 9C show that the longer the d₄ the higher the impedance of the PCB antenna 900.

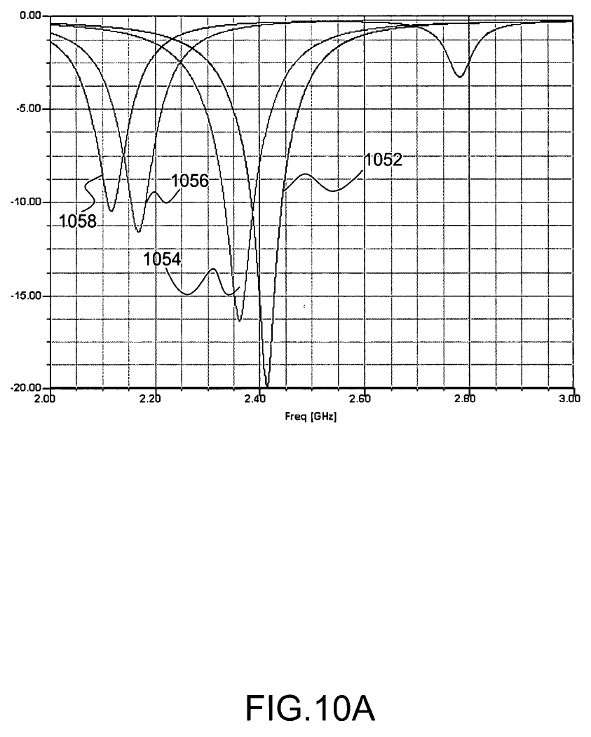

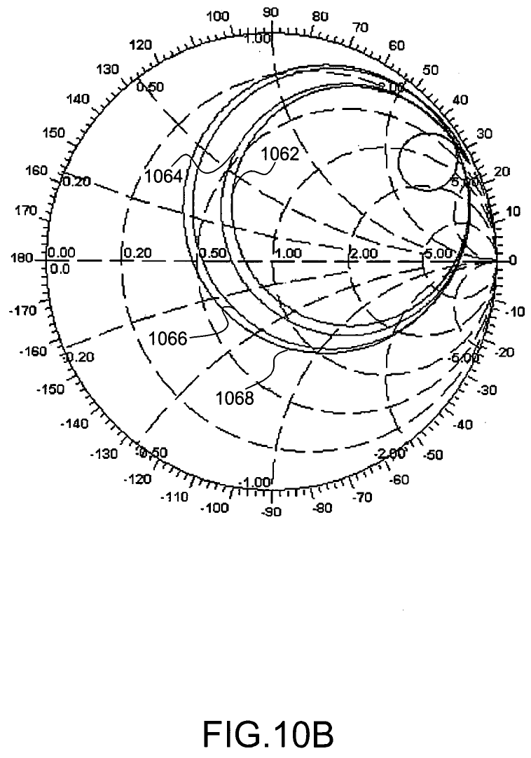

Back to FIG. 8A, if d₃ is fixed at 1 mm and the capacitance of the 0402 capacitor 820 is varied, the experimental results of the PCB antenna 800 are shown in FIG. 10A and FIG. 10B. There are four curves 1052, 1054, 1056 and 1058 depicted in FIG. 10A. The curve 1052 is depicted when the capacitance of the 0402 capacitor 820 has a value of 1 pF. The curve 1054 is depicted when the capacitance of the 0402 capacitor 820 has a value of 2 pF. The curve 1056 is depicted when the capacitance of the 0402 capacitor 820 has a value of 3 pF. The curve 1058 is depicted when the capacitance of the 0402 capacitor 820 having a value of 4 pF. There are also four curves 1062, 1064, 1066 and 1068 depicted in FIG. 10B corresponding to the curves 1052, 1054, 1056 and 1058. As a result, the curves depicted in FIG. 10A show that the larger the capacitance the lower the resonant frequency of the PCB antenna 800, and the curves depicted in FIG. 10B show that the larger the capacitance the lower the impedance of the PCB antenna 800.

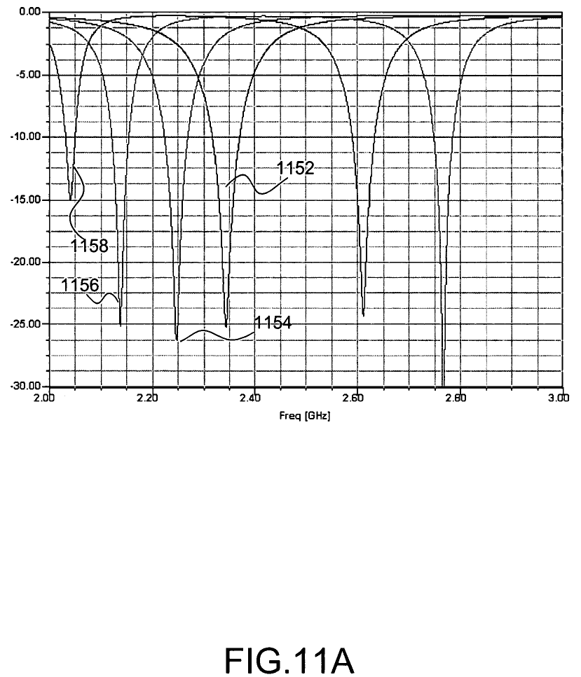

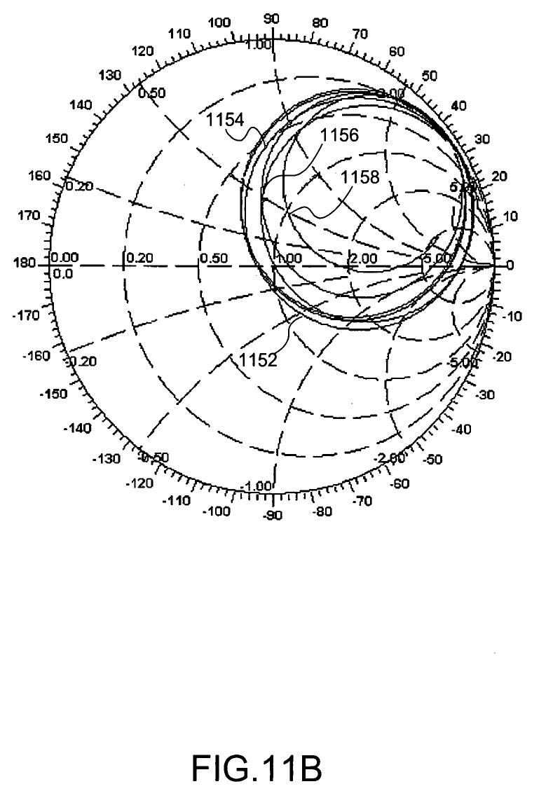

Back to FIG. 9A, if d₄ is fixed at 1 mm and the capacitance of the 0402 capacitor 920 is varied, the experimental results of the PCB antenna 900 are shown in FIG. 11A and FIG. 11B. There are four curves 1152, 1154, 1156 and 1158 depicted in FIG. 11A. The curve 1152 is depicted when the capacitance of the 0402 capacitor 920 has a value of 1 pF. The curve 1154 is depicted when the capacitance of the 0402 capacitor 920 has a value of 2 pF. The curve 1156 is depicted when the capacitance of the 0402 capacitor 920 has a value of 3 pF. The curve 1156 is depicted when the capacitance of the 0402 capacitor 920 having a value of 4 pF. There are also four curves 1162, 1164, 1166 and 1168 depicted in FIG. 11B corresponding to the curves 1152, 1154, 1156 and 1158. As a result, the curves depicted in FIG. 11A show that the larger the capacitance the lower the resonant frequency of the PCB antenna 900, and the curves depicted in FIG. 11B show that the larger the capacitance the higher the impedance of the PCB antenna 900.

It should be noted that, from FIG. 10A, FIG. 10B, FIG. 11A and FIG. 11B, the variations in resonant frequency and impedance are enlarged with the capacitance of the 0402 capacitor increasing.

Consequently, if an inductor is mounted on the top surface as shown in FIG. 4A, the resonant frequency is increased and the input impedance is increased while the distance (i.e. d₁ as described above) increases. If an inductor is mounted on the bottom surface as shown in FIG. 5A, the resonant frequency is increased and the input impedance is decreased while the distance (i.e. d₂ as described above) increases. In addition, if a capacitor is mounted on the top surface as shown in FIG. 8A, the resonant frequency is decreased and the input impedance is decreased while the distance (i.e. d₃ as described above) increases. If a capacitor is mounted on the bottom surface as shown in FIG. 9A, the resonant frequency is decreased and the input impedance is increased while the distance (i.e. d₄ as described above) increases. In other words, if increasing the resonant frequency with decreasing the input impedance of a PCB antenna is desired, mounting a capacitor on the bottom surface with suitable distance may be chose. And if the scale-up of variation is desired, a capacitor with higher capacitance may be chose.

Throughout the present invention, a method for adjusting the resonant frequency and input impedance of a PCB antenna and a structure thereof are provided for a designer to tune the resonant frequency and input impedance of the PCB antenna easily and economically without any other matching circuit needed. Moreover, it is advantageous that the resonant frequency and input impedance of the PCB antenna may be tuned to desired value. That is, the performances of the PCB antenna of the present invention having different passive elements at different distances or locations are continuous.

The present invention has been described above with reference to preferred embodiments. However, those skilled in the art will understand that the scope of the present invention need not be limited to the disclosed preferred embodiments. On the contrary, it is intended to cover various modifications and equivalent arrangements within the scope defined in the following appended claims. The scope of the claims should be accorded the broadest interpretation so as to encompass all such modifications and equivalent arrangements.

What is claimed is:

1. A PCB antenna, comprising:
a substrate;
a radiator, patterned on the substrate, having a branch point;
a ground on the substrate;
a short path, patterned on the substrate, having two ends where one end is connected to the ground and the other end is connected to the branch point of the radiator; and
at least one passive element, coupled between the radiator and the short path, for adjusting a resonant frequency and/or an input impedance of the PCB antenna.

2. The PCB antenna of claim 1, wherein the at least one passive element is disposed on a top surface of the substrate, a bottom surface of the substrate or combination thereof.

3. The PCB antenna of claim 1, wherein the resonant frequency and/or the input impedance of the PCB antenna are adjusted according to a distance between the passive element and the branch point of the radiator.

4. The PCB antenna of claim 1, wherein the at least one passive element comprises a resistance, a capacitor, an inductor or combination thereof.

5. A method for adjusting a PCB antenna, comprising the following steps:
(a) providing the PCB antenna, comprising
a substrate;
a radiator, patterned on the substrate, having a branch point;
a ground on the substrate;
a short path, patterned on the substrate, having two ends where one end is connected to the ground and the other end is connected to the branch point of the radiator; and
at least one passive element, coupled between the radiator and the short path; and
(b) adjusting a resonant frequency and/or an input impedance of the PCB antenna according to a distance between the passive element and the branch point of the radiator.

6. The method of claim 5, wherein the at least one passive element comprises a resistance, a capacitor, an inductor or combination thereof.

7. A portable communication device, comprising:
a RF device; and
a PCB antenna coupled to the RF device, comprising:
a substrate;
a radiator, patterned on the substrate, having a branch point;
a ground on the substrate;
a short path, patterned on the substrate, having two ends where one end is connected to the ground and the other end is connected to the branch point of the radiator; and
at least one passive element, coupled between the radiator and the short path, for adjusting a resonant frequency and/or an input impedance of the PCB antenna.

8. The portable communication device of claim 7, wherein the at least one passive element is disposed on a top surface of the substrate, a bottom surface of the substrate or combination thereof.

9. The portable communication device of claim 7, wherein the resonant frequency and/or the input impedance of the PCB antenna are adjusted according to a distance between the passive element and the branch point of the radiator.

10. The portable communication device of claim 7, wherein the at least one passive element comprises a resistance, a capacitor, an inductor or combination thereof.
